(19) United States
(12) Patent Application Publication
(10) Pub. No.: US 2010/0049946 A1
(43) Pub. Date: Feb. 25, 2010

(54) PROCESSOR, COMPUTER READABLE RECORDING MEDIUM, AND STORAGE DEVICE

(75) Inventors: Nobuyuki Myouga, Kawasaki (JP); Kazuhiko Takaishi, Kawasaki (JP); Yoshinari Higashino, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/480,512

(22) Filed: Jun. 8, 2009

(30) Foreign Application Priority Data
Aug. 25, 2008 (JP) 2008-215687

(51) Int. Cl. G06F 9/312

(52) U.S. Cl. 712/205; 712/E09.033

(57) ABSTRACT

A processor includes: a first storage part that stores instructions of a program including sets of instruction groups, which sets are hierarchically structured; a second storage part that stores an address value of the first storage part in which an instruction to be read next is stored; a third storage part that includes storage areas respectively corresponding to hierarchical levels of the program; and a control part that executes, when an instruction read from the first storage part is a call instruction that calls a different one of the sets of instruction groups, a control to store the address value in the second storage part in one of the storage areas of the third storage part that corresponds to one of the hierarchical levels with which the different one of the sets of instruction groups being executed is associated.

### CROSS-REFERENCE TO RELATED APPLICATION

This application is based upon and claims the benefit of priority of the prior Japanese Patent Application No. 2008-215687, filed on Aug. 25, 2008, the entire contents of which are incorporated herein by reference.

### FIELD

A certain aspect of the embodiment discussed herein is related to a processor, a computer readable recording medium, and a storage device.

### BACKGROUND

A program that has sets of several instruction groups hierarchically structured is known. For example, there is a program that calls and executes another function during execution of a main routine. When a processor executing a program calls a lower-level instruction group during execution of a higher-level instruction group, the processor is required to save data that are necessary to let a process return to the higher-level instruction group to a save area, as is disclosed in Japanese Laid-open Patent Publication No. 55-33236. The above data contain information such as a local variable, an argument and a return address that indicates an address to which the processor returns after processing an instruction group that is called.

When the processor calls an even lower-level instruction group during execution of the lower-level instruction group that is called, the processor may be required to reserve several save areas and to store information that indicate which hierarchy data are stored in the several save areas.

### SUMMARY

According to an aspect of the present invention, there is provided a processor including: a first storage part that stores instructions of a program including sets of instruction groups, which sets are hierarchically structured; a second storage part that stores an address value of the first storage part in which an instruction to be read next is stored; a third storage part that includes storage areas respectively corresponding to hierarchical levels of the program; and a control part that executes, when an instruction read from the first storage part is a call instruction that calls a different one of the sets of instruction groups, a control to store the address value in the second storage part in one of the storage areas of the third storage part that corresponds to one of the hierarchical levels with which the different one of the sets of instruction groups being executed is associated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a processor;

FIG. 2 is a block diagram both of a CPU and a RAM;

FIG. 3 illustrates execution procedures of a program that has a hierarchic structure;

FIG. 4 illustrates values of a program counter stored in a stack area when a function is called;

FIG. 5 is a block diagram of a disk storage device;

FIG. 6 is a block diagram of a second processor;

FIG. 7 illustrates procedures executed by a first processor;

FIG. 8A is a flowchart illustrating procedures when a first processor reads a CALL instruction, and FIG. 8B is a flowchart illustrating procedures when a second processor reads a CALL instruction; and

FIG. 9A is a flowchart illustrating procedures when a first processor reads a RETURN instruction, and FIG. 9B is a flowchart illustrating procedures when a second processor reads a RETURN instruction.

### DESCRIPTION OF EMBODIMENTS

As described previously, when the processor calls an even lower-level instruction group during execution of the lower-level instruction group that is called, the processor may be required to reserve several save areas and to store information that indicate which hierarchy data are stored in the several save areas. However, it causes a complexity of the processor structure.

Preferred embodiments of the present invention will be explained with reference to accompanying drawings.

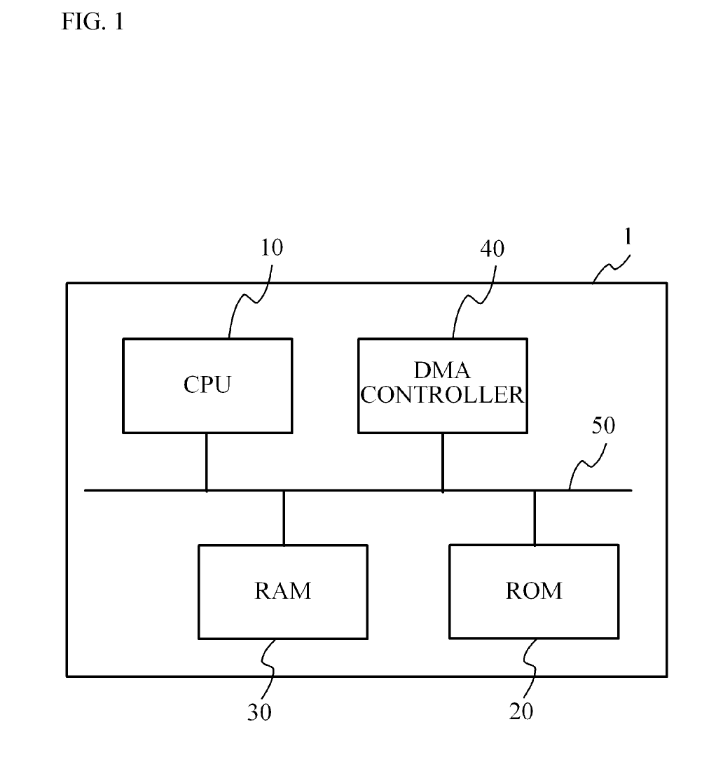

First, a structure of this embodiment is described with reference to FIG. 1. As illustrated in FIG. 1, a processor 1 of this embodiment has a CPU (Central Processing Unit) 10, a ROM (Read Only Memory) 20, a RAM (Random Access Memory) 30, and a DMA (Direct Memory Access) controller 40. The CPU 10, the ROM 20, the RAM 30 and the DMA controller 40 are connected to a system bus 50. The DMA controller 40 controls transferring and writing programs stored in the ROM 20 to the RAM 30. The CPU 10 reads the programs transferred to the RAM 30 from the ROM 20 by the control of the DMA controller 40, and carries out operations by the program the CPU 10 has read.

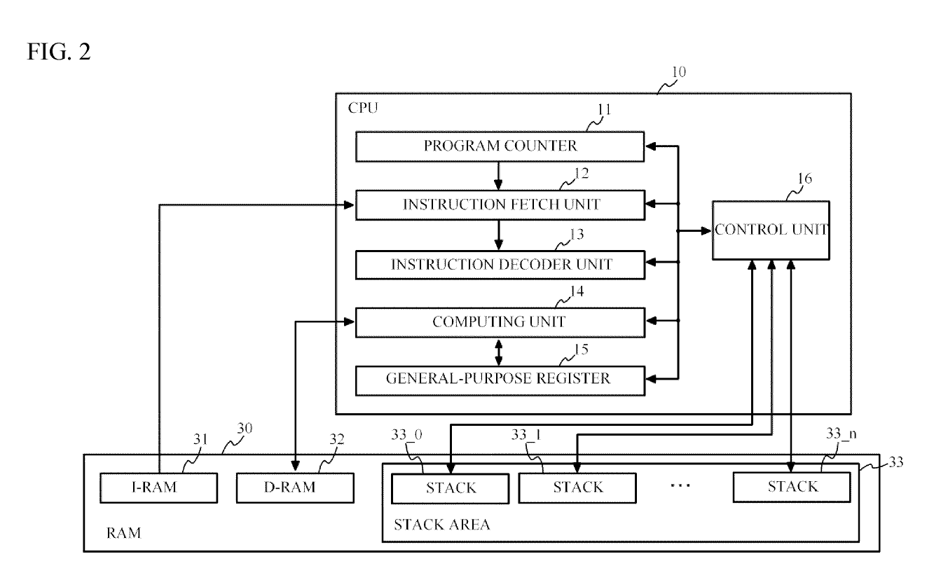

FIG. 2 illustrates detail structures of the CPU 10 and the RAM 30. A storage area of the RAM 30 is divided into an instruction RAM (I-RAM) 31, a data RAM (D-RAM) 32 and a stack area 33.

The I-RAM 31 stores programs (instruction groups) read out from the ROM 20 by the control of the DMA controller 40. The D-RAM 32 stores data that the CPU 10 uses for operations. The stack area 33 is divided into several areas. In this embodiment, the stack area 33 is divided into n+1 areas (33_0, 33_1, . . . , and 33_{—}n (n is any natural number)). The stack areas (33_0, 33_1, . . . , and 33_{—}n) are given depending on a process level of the program. For example, each of the process levels corresponds to the respective hierarchical level of a nested program. Nest means configuring the program by making sets of several instruction groups and structuring the sets of the instruction groups hierarchically. In the following description, the stack areas (33_0, 33_1, and 33_{—}n) are called simply the stack area 33 when they are called collectively.

The CPU 10 has a program counter 11, an instruction fetch unit 12, an instruction decoder unit 13, a computing unit 14, a general-purpose register 15 and a control unit 16, as illustrated FIG. 2.

The program counter 11 stores a value (counter value) that corresponds to an address of the I-RAM 31 storing an instruction which the instruction fetch unit 12 reads from the I-RAM 31 next. The instruction fetch unit 12 reads the instruction from an address of the I-RAM 31 that the program counter 11 indicates. The instruction fetch unit 12 outputs the instruction to the instruction decoder unit 13. The instruction decoder unit 13 analyzes the instruction that has been read by the instruction fetch unit 12. The instruction decoder unit 13 outputs an analytical result to the control unit 16.

When the control unit 16 determines that an operation is requested based on the analytical result of the instruction from the instruction decoder unit 13, the control unit 16 outputs the instruction to the computing unit 14. When the control unit 16 determines that the analytical result from the instruction decoder unit 13 is a CALL instruction that calls another function, the control unit 16 stores an address value that the program counter 11 stores and variables stored in the general-purpose register 15 in the stack area 33.

The stack area 33 has the storage areas each corresponding to the respective hierarchical levels of the program that has the sets of the instruction groups hierarchically structured as described before. For example, when the instruction group that contains the CALL instruction that calls another function is the highest-level instruction group, the control unit 16 stores the address value of the program counter 11 and the value of the general-purpose register 15 in the stack area 33_0 that corresponds to the highest-level instruction group.

When the analytical result from the instruction decoder unit 13 is a RETURN instruction to return to a higher-level function or a higher-level routine from a lower-level function, the control unit 16 shifts the process to the higher-level function or the higher-level routine based on the address value of the program counter 11.

The computing unit 14 executes operations by reading data from the general-purpose register 15 and the D-RAM 32 by the instruction from the control unit 16. The computing unit 14 stores the data of the operational result in the D-RAM 32 and the general-purpose register 15.

The general-purpose register 15 stores a variety of variables the computing unit 14 uses during the operations. A variety of variables may include a local variable (a variable used in an only one function or one routine), and an argument (a variable used in a called function or a called subroutine).

According to this embodiment, the RAM 30 has the stack areas 33 each corresponding to the respective hierarchical levels of the hierarchical program. The dedicated stack area 33 corresponds to the CALL instruction and the RETURN instruction. When another function or another routine is called during execution of a certain function or a certain routine, the control unit 16 stores the value of the program counter 11 and the value of the general-purpose register 15 in the stack area 33 corresponding to the hierarchical level.

The dedicated stack area 33 corresponding to the CALL instruction means that it depends on the CALL instruction in which stack area 33 the control unit 16 writes the value of the program counter 11 and the value of the general-purpose register 15. For example, when the instruction fetch unit 12 reads a CALL 0 instruction, the control unit 16 writes the value of the program counter 11 and the value of the general-purpose register 15 in the stack area 33_0. The dedicated stack area 33 corresponding to the RETURN instruction means that it depends on the RETURN instruction read in which stack area 33 the control unit 16 restores the value of the program counter 11 and the value of the general-purpose register 15 with the information which is stored. For example, when the instruction fetch unit 12 reads a RETURN 0, the control unit 16 restores the value of the program counter 11 and the value of the general-purpose register 15 with the information stored in the stack area 33_0.

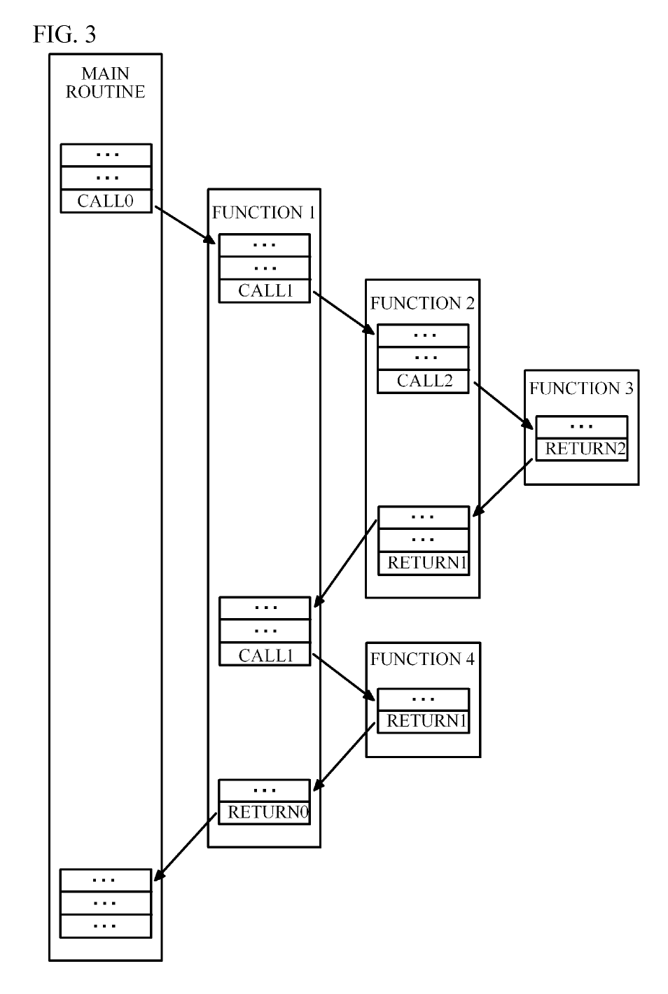

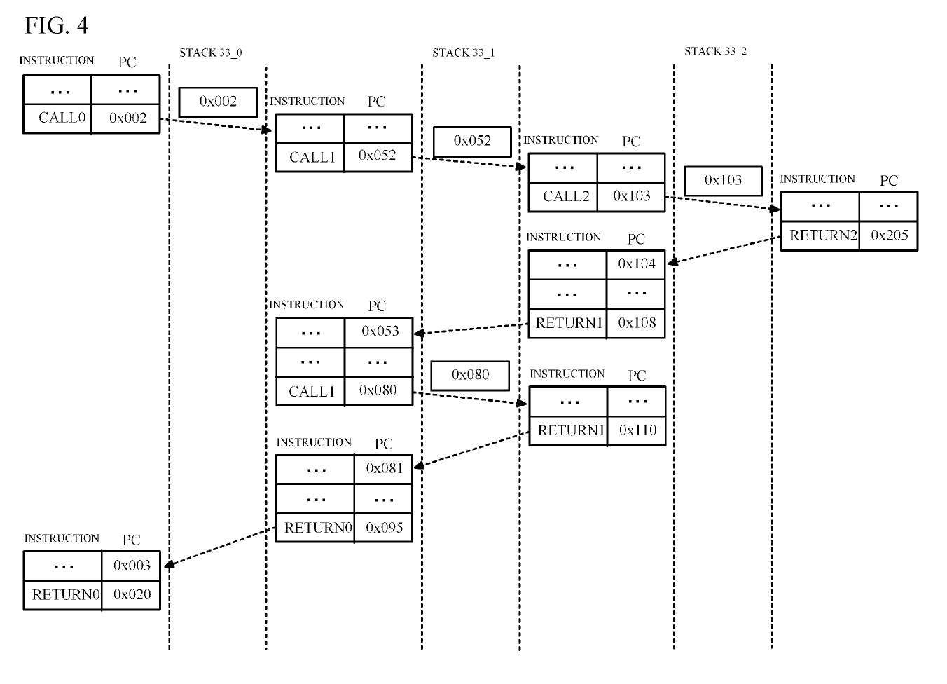

A process of the processor 1 when the processor 1 reads the CALL instruction or the REUTN instruction is described with reference to FIG. 3 and FIG. 4. FIG. 3 and FIG. 4 illustrate procedures when a hierarchical structure of the program has three hierarchical levels. Three stack areas that are the stack area (33_0, 33_1, 33_2) are used in the stack area 33, because the hierarchical structure of the program has three hierarchical levels.

As illustrated in FIG. 3, when the CALL instruction is read by the instruction fetch unit 12 during execution of a main routine (this CALL instruction is now referred to as CALL 0), the control unit 16 stores the value of the program counter 11 and the value of the general-purpose register 15 in the stack area 33_0 by the instruction of the CALL 0. The control unit 16 saves the value of the program counter 11 and the value of the general-purpose register 15 to the stack area 33_0, because the main routine is the highest-level routine. FIG. 4 illustrates a state that the control unit 16 stores the value of the program counter 11 [0x002] in the stack area 33_0 by the instruction of the CALL 0. The function called by the CALL 0 is described as function 1 in the following description. FIG. 4 does not illustrate the value of the register 15 saved to the stack area 33_0.

Then, the control unit 16 executes the function 1 that has been called. When the control unit 16 reads the CALL instruction (call this instruction a CALL 1) with the instruction fetch unit 12 during execution of the function 1, the control unit 16 stores the value of the program counter 11 and the value of the general-purpose register 15 in the stack area 33_1 by the instruction of the CALL 1 that the instruction fetch unit 12 has read. The control unit 16 saves the value of the program counter 11 and the value of the general-function register 15 to the stack area 33_1, because the function 1 is one level lower than the main routine that is the highest level. FIG. 4 illustrates the state that the control unit 16 stores the value of the program counter 11 [0x052] in the stack area 33_1 by the instruction of the CALL 1. The function called by the CALL 1 is described as function 2 in the following description. FIG. 4 does not illustrate the value of the genera-purpose register 15 saved to the stack area 33_1.

In the same way as described above, the control unit 16 executes the function 2 that has been called by the CALL 1. When the control unit 16 reads the CALL instruction (call this instruction a CALL 2) with the instruction fetch unit 12 during execution of the function 2, the control unit 16 saves the value of the program counter 11 and the value of the general-purpose register 15 to the stack area 33_2 by the instruction of the CALL 2 that the instruction fetch unit 12 has read. The control unit 16 saves the value of the program counter 11 and the value of the general-purpose register 15 to the stack area 33_2, because the function 2 is the two-level lower function than the main routine that is the highest level. FIG. 4 illustrates the state that the control unit 16 stores the value of the program counter 11 [0x103] by the instruction of the CALL 2. The function called by the CALL 2 is described as function 3 in the following description. FIG. 4 does not illustrate the value of the general-purpose register 15 saved to the stack area 33_2.

The control unit 16 executes the function 3 that has been called by the CALL 2. When the control unit 16 reads the RETURN instruction during execution of the function 3 (this instruction is referred to as RETURN 2), the control unit 16 restores the value of the program counter 11 and the value of the general-purpose register 15 with the information that the control unit 16 saved to the stack area 33_2. In the embodiment illustrated in FIG. 4, [0x103] is saved to the stack area 33_2 as the value of the program counter 11. Therefore, the control unit 16 returns to the function 2 that is the higher-level function than the function 3 with [0x104], which is the value that the control unit 16 adds one to this value [0x0103] as the value of the program counter 11.

In the same way as described above, the control unit 16 executes the function 2 to which the control unit 16 has shifted by the instruction of the RETURN 2. When the control unit 16 reads out the RETURN instruction (call this instruction a RETURN 1) during execution of the function 2, the control unit 16 restores the value of the program counter 11 and the value of the general-purpose register 15 with the information that the control unit 16 saved to the stack area 33_1. In this embodiment illustrated in FIG. 4, [0x052] is saved to the stack area 33_1 as the value of the program counter 11. Therefore the control unit 16 returns to the function 1 that is the higher-level function than the function 2 with [0x053], which is the value that the control unit 16 adds one to this value [0x052] as the value of the program counter 11.

The control unit 16 executes the function 1 to which the control unit 16 has shifted by the instruction of the RETURN 1. When the control unit 16 reads the CALL 1 during execution of the function 1, the control unit 16 saves the value of the program counter 11 and the value of the general-purpose register 15 to the stack area 33_1 by the instruction of the CALL 1. The control unit 16 saves the value of the program counter 11 and the value of the general-purpose register 15 to the stack area 33_1, because the function 1 is one level lower than the main routine that is the highest-level. FIG. 4 illustrates the state that the value of the program counter 11 [0x080] is stored in the stack area 33_1 by the control of the control unit 16. FIG. 4 does not illustrate the value of the general-purpose register 15 saved to the stack area 33_1.

The control unit 16 repeats the same processes as described above, and returns the processes to the process of the main routine and completes the processes by executing the process of the main routine.

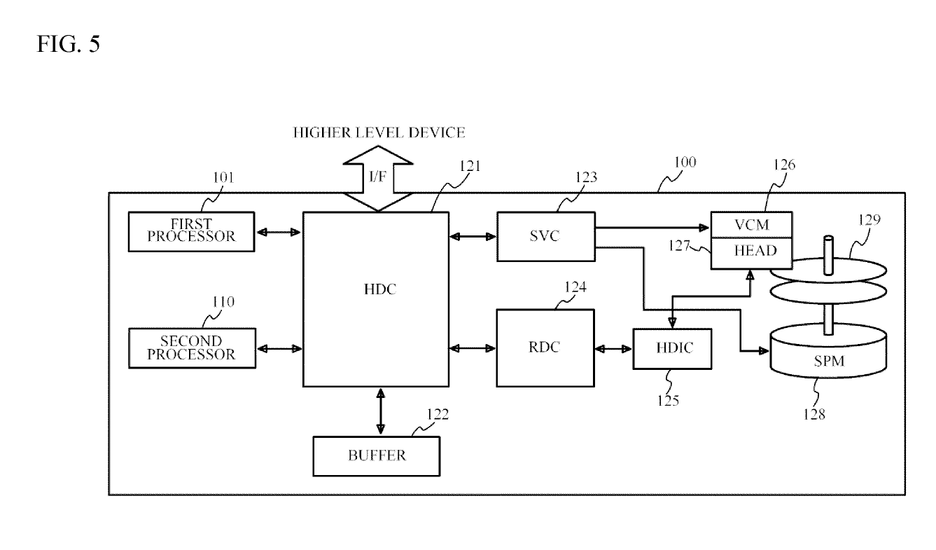

FIG. 5 illustrates a structure of the disk storage drive 100 that has the processor 1 illustrated in FIG. 1.

The disk storage drive 100 illustrated in FIG. 5 has two processors, which are a first processor 101 and a second processor 110. At least one of the processor 101 and the second processor 110 corresponds to the processor 1 illustrated in FIG. 1. Although FIG. 5 illustrates the disk storage drive 100 that has the first processor 101 and the second processor 110, the number of the processor that the disk storage drive 100 has is not limited to two and the disk storage drive 100 may have more than two processors.

A hard disk controller (HDC) 121 controls an interface protocol, a buffer 122, and a disk formatting. A servo control circuit (SVC) 123 controls a voice coil motor (VCM) 126 and a spindle motor (SPM) 128. A read channel (RDC) 124 writes data to a magnetic disk 129 used as a record medium and reads data from the magnetic disk 129. A head IC (HDIC) 125 is an IC that controls a movement of a head 127. Specifically, when reading data, this head IC 125 behaves as a preamplifier to amplify a signal read out and as a bias current source for the head. And the head IC 125 behaves as a driver of the head 127 when writing data. The VCM 126 drives an actuator that supports the head 127. The SPM 128 spins the magnetic disk 129.

The second processor (a main processor) 110 controls comparatively complicate processes. For example, the second processor 110 controls the HDC 121, the SVC 123 and the RDC 124 by a command that the second processor gets from an higher level device, and controls writing data to the magnetic disk 129 and reading data from the magnetic disk 129. Further, the second processor 110 manages the buffer 122 through the HDC 121. When an error occurs in the disk storage drive 100, the second processor 110 controls the HDC 121, the SVC 123 and the RDC 124 to recover from the error.

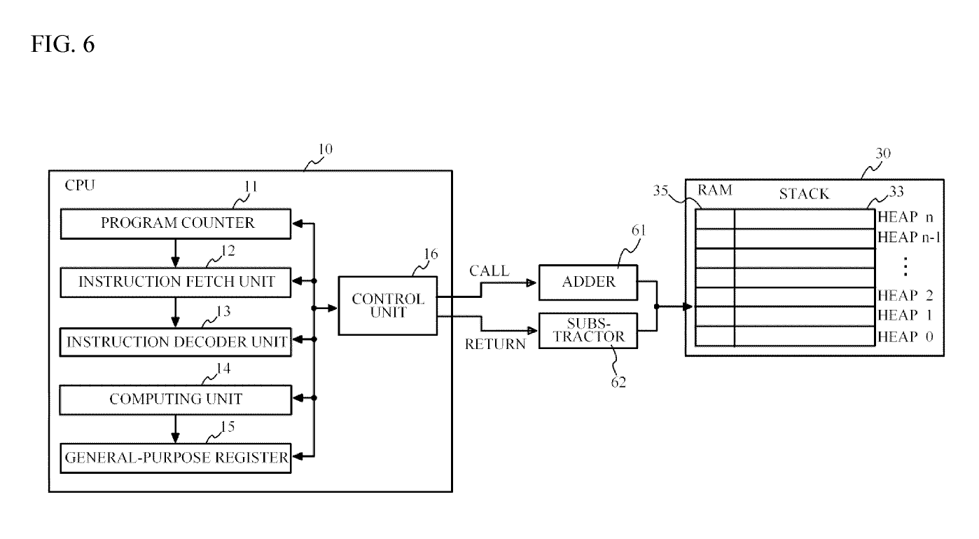

FIG. 6 illustrates another structure of the second processor 110. The second processor 110 may have the structure illustrated in FIG. 2 or in FIG. 6. Compared to the first processor 101, the second processor 110 has an adder 61 and a subtractor 62, which are hardware. Additionally the second processor 110 has a storage area 35 that stores the value of a stack pointer in the stack area 33 of the RAM 30. The stack area 33 has a heap structure (a heap 0 through a heap n (n is any natural number)) divided into several tiers.

When the control unit 16 of the second processor 110 reads the CALL instruction with the instruction fetch unit 12, the control unit 16 of the second processor 110 activates the adder 61 and adds one to a value of the stack pointer. The value of the stack pointer to which the adder 61 has added one is stored in the storage area 35. The control unit 16 stores the value of the program counter 11 and the value of the general-purpose register 15 in the heap of the tier indicated by the stack pointer.

When the control unit 16 of the second processor 110 reads the RETURN instruction with the instruction fetch unit 12, the control unit 16 of the second processor 110 gets the information from the heap of the tier indicated by the stack pointer, and restores the value of the program counter 11 and the general-purpose register 15. When the control unit 16 restores the value of the program counter 11 and the value of the general-purpose register 15, the control unit 16 activates the subtractor 62 and deducts one from the value of the stack pointer. The value of the stack pointer from which the subtractor 62 has deducted one is stored in the storage area 35.

The first processor 101 executes the servo control process that demands fast processing though is comparatively simple. The servo control process includes a process that calculates the amount of the actuator's drive to move the head 127 to a data writing position or to a data reading position based on the positional information stored in the magnetic disk 129 in advance. The servo control process includes functions such as a position-demodulation-calculation, a current-calculation and an eccentricity-offset-calculation.

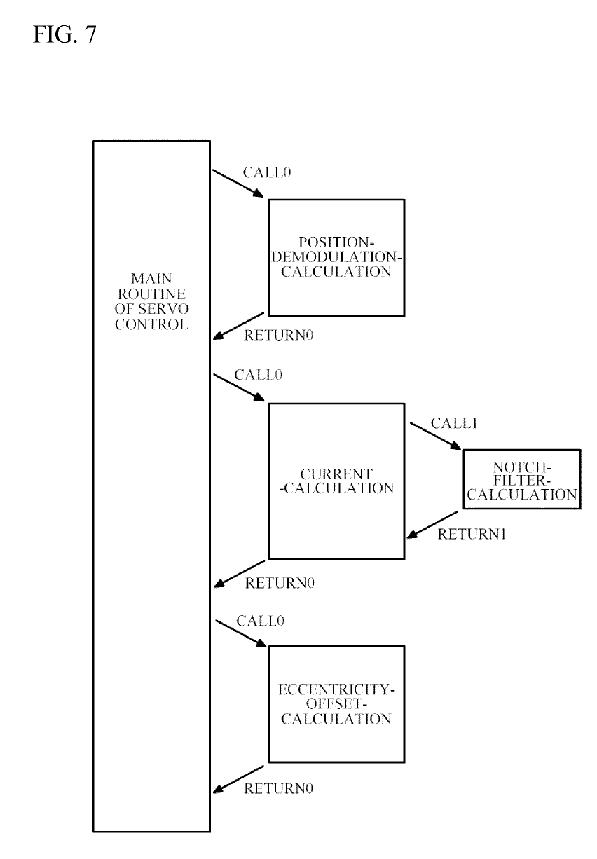

An overview of the processes of the first processor 101 that executes the servo control is illustrated in FIG. 7.

The position demodulation calculation is a process to determine a current position of the head 127 based on the servo information recorded in the magnetic disk 129. The current calculation is a process to calculate the amount of current supplied to the actuator to adjust the head position by a seek control or a track following control. The eccentricity offset calculation is a process that corrects a displacement of the center axis of the SPM 128 after the SPM 128 is assembled as a disk storage drive and corrects a displacement when the servo information is written in the magnetic disk 129.

When the condition to call the position demodulation calculation, current calculation and eccentricity offset calculation is filled, the control unit 16 of the first processor 101 stores, in the stack area 33_0, the value of the program counter 11 and the value of the general-purpose register 15 used for the process of the main servo control by the control unit 16 responsive to the instruction of the CALL 0. After that, the control unit 16 executes the position demodulation calculation, the current calculation and the eccentricity offset calculation, reads the instruction of the RETURN 0, and restores the value of the program counter 11 and the value of the general-purpose register 15 with the value that the control unit 16 has stored in the stack area 33_0.

A notch filter calculation process is called as a lower function during execution of the function that executes the current-calculation. The notch filter calculation process is a filtering process to remove a mechanical resonance.

When the control unit 16 reads the instruction of the CALL 1 during execution of the function of the current-calculation, the control unit 16 stores the value of the program counter 11 and the value of the general-purpose register 15 used for the current-calculation, in the stack area 33_1 by the control unit 16. After that, the control unit 16 executes the notch-filter-calculation process, reads the instruction of the RETURN 1, and restores the value of the program counter 11 and the value of the general-purpose register 15 with the value that the control unit 16 has stored in the stack area 33_1.

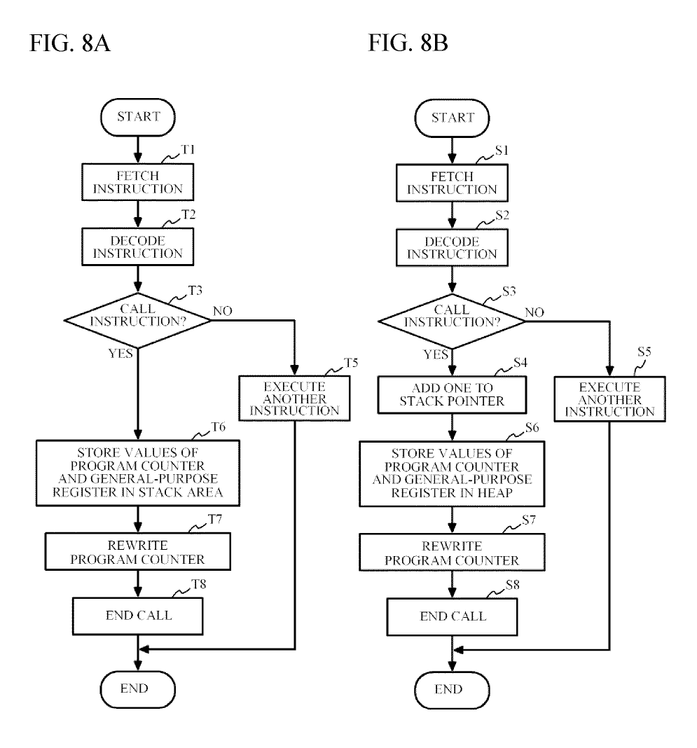

FIG. 8A illustrates procedures of the first processor 101 when the first processor 101 reads the CALL instruction. FIG. 8B illustrates procedures of the second processor 110 when the second processor 110 reads the CALL instruction. First, the procedures of the first processor 101 are described with reference to FIG. 8A.

First, the first processor 101 reads the instruction from the address of the I-RAM 31 indicated by the program counter 11 with the instruction fetch unit 12 (step T1). Next, the first processor 101 analyzes the instruction read by the instruction fetch unit 12 with the instruction decoder unit 13 (step T2). The instruction decoder unit 13 outputs an analytical result to the control unit 16.

When the control unit 16 of the first processor 101 determines that the analytical result by the instruction decoder unit 13 is the CALL instruction to call another function (step T3/YES), the control unit 16 of the first processor 101 stores the address values that the program counter 11 stores and variables stored in the general-purpose register 15 in the corresponding area of the stack area 33 (step T6). After that, the control unit 16 of the first processor 101 rewrites the value of the program counter 11 (step T7), and ends the CALL instruction (step T8). When the control unit 16 of the first processor 101 determines that the analytical result is not the CALL instruction to call another function, the control unit 16 of the first processor 101 outputs the another instruction read by the control unit 16 to the computing unit 14 and gets the computing unit 14 to execute an operation (step T5).

In the procedures of the second processor 110 illustrated in FIG. 8B, when the control unit 16 of the second processor 110 determines that the analytical result is the CALL instruction (step S3/YES), the procedure that the control unit 16 of the second processor 110 adds one to the value of the stack pointer by using the adder 61 is added. After adding one to the stack pointer, the control unit 16 of the second processor 110 stores the value of the program counter 11 and the value of the general-purpose register 15 in the heap indicated by the stack pointer to which the control unit 16 added one. It is obvious by comparing FIG. 8A and FIG. 8B that the process of the first processor 101 can be speeded up more than the process of the second processor 110, because the process of the first processor 101 does not have the procedure that the control unit 16 adds one to the stack pointer.

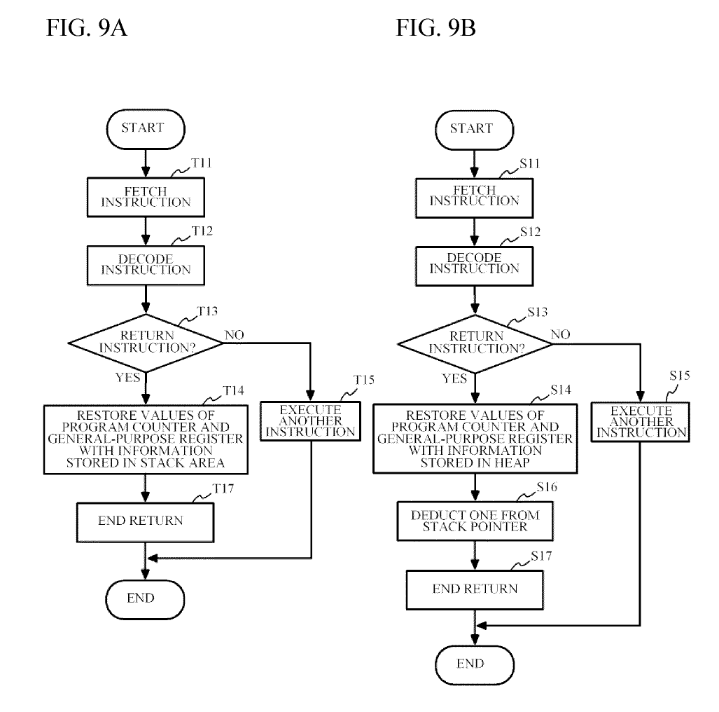

Then, the procedures of the first processor 101 and the procedures of the first processor 102 carried out when the control unit 16 reads the RETURN instruction are described with reference to FIG. 9A and FIG. 9B.

FIG. 9A illustrates procedures of the first processor 101 when the first processor 101 reads the RETURN instruction. And FIG. 9B illustrates procedures of the second processor 110 when the second processor 110 reads the RETURN instruction.

First, the procedures of the first processor 101 are described with reference to the FIG. 9A.

The first processor 101 reads the instruction from the address of the I-RAM 31 indicated by the program counter 11 with the instruction fetch unit 12 (step T11). Then the first processor 101 analyzes the instruction that has been read by the instruction fetch unit 12 with the instruction decoder unit 13 (step T12). The instruction decoder unit 13 outputs an analytical result to the control unit 16.

When the control unit 16 of the first processor 101 determines that the instruction read by the instruction fetch unit 12 is the RETURN instruction (step T13/YES), the control unit 16 of the first processor 101 restores the value of the program counter 11 and the value of the general-purpose register 15 by using the information stored in the stack area 33 (step T14). The control unit 16 of the first processor 101 executes the higher-level function than the function that includes the RETURN instruction (step T17).

When the control unit 16 of the first processor 101 determines that the instruction read by the instruction fetch unit 12 is not the RETURN instruction (step T13/NO), the control unit 16 of the first processor 101 outputs another instruction read by the control unit 16 to the computing unit 14 and gets the computing unit 14 to execute an operation (step T15).

In the process of the second processor 110 illustrated in FIG. 9B, after the control unit 16 of the second processor 110 restores the value of the program counter 11 and the value of the general-purpose register 15 with the information stored in the stack area 33 (step T14), the control unit 16 deducts one from the value of the stack pointer (step S16).

It is obvious by comparing FIG. 9A to FIG. 9B that the process of the first processor 101 can be speeded up more than the process of the second processor 110, because the process of the first processor 101 does not have the procedure that the control unit 16 deducts one from the stack pointer.

As described above, the first processor 1 of this embodiment can improve the processing speed of the program composed of the sets of instruction groups hierarchically structured.

The disk storage drive 100 with the processor 1 can improve the performance as a whole device because the disk storage drive 100 reduces the processing load of the second processor by using the first processor 1 for operations that demand fast processing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various change, substitutions, and alterations could be made hereto without departing from the spirit and scope of the invention.

What is claimed is:

1. A processor comprising:
a first storage part that stores instructions of a program including sets of instruction groups, which sets are hierarchically structured;
a second storage part that stores an address value of the first storage part in which an instruction to be read next is stored;
a third storage part that includes storage areas respectively corresponding to hierarchical levels of the program; and
a control part that executes, when an instruction read from the first storage part is a call instruction that calls a different one of the sets of instruction groups, a control to store the address value in the second storage part in one of the storage areas of the third storage part that corresponds to one of the hierarchical levels with which the different one of the sets of instruction groups being executed is associated.

2. The processor as claimed in claim 1, further comprising a fourth storage part that store information that includes a result of an operation executed by the different one of the sets of instruction groups being executed and variables used thereby, wherein the control part stores the information stored in the fourth storage part in said one of the storage areas of the third storage part.

3. A computer readable medium storing a program causing a computer to execute a process, the process comprising:
determining whether an instruction read from a first storage part which stores instructions of a program including sets of instruction groups hierarchically structured is a call instruction which calls a different one of the sets of instruction groups;
reading an address value of the first storage part which stores an instruction to be read next from a second storage part storing the address value, when the instruction is the call instruction to call the different one of the sets of instruction groups; and
storing the address value in the second storage part in one of storage areas of a third storage part respectively corresponding to hierarchical levels of the program,
the different one of the sets of instruction groups that includes the call instruction and is executed being associated with said one of the storage areas.

4. A storage device comprising:
a storage medium that stores data magnetically;
a head that writes data to the storage medium and reads data from the medium;
an actuator that moves the head; and
a first processor that controls to write and read data in and from the recording medium; and
a second processor, the second processor including:
a first storage part that stores instructions of a program including sets of instruction groups, which sets are hierarchically structured,
a second storage part that stores an address value of the first storage part in which an instruction to be read next is stored,
a third storage part that includes storage areas respectively corresponding to hierarchical levels of the program, and
a control part that executes, when an instruction read from the first storage part is a call instruction that calls a different one of the sets of instruction groups, a control to store the address value in the second storage part in one of the storage areas of the third storage part that corresponds to one of the hierarchical levels with which the different one of the sets of instruction groups being executed is associated,
the second processor computing an amount of drive necessary to drive an actuator to move the head to a date writing position or a data reading position of the recording medium by referring to positional information stored in the storage medium.
